(19) United States
(12) Patent Application Publication
(10) Pub. No.: US 2008/0100975 A1
(43) Pub. Date: May 1, 2008

(54) DISTRIBUTION AUTOMATION SYSTEM

(76) Inventors: No-Gil Myoung, Daejeon Metropolitan City (KR); In-Ji Choi, Daejeon Metropolitan City (KR); Young-Hyun Kim, Daejeon Metropolitan City (KR); Byung-Seok Park, Daejeon Metropolitan City (KR); Seong-Ho Ju, Daejeon Metropolitan City (KR); Moon-Seok Choi, Daejeon Metropolitan City (KR)

Correspondence Address: MORGAN & FINNEGAN, L.L.P., 3 WORLD FINANCIAL CENTER, NEW YORK, NY, 10281-2101, US

(21) Appl. No.: 11/928,482

(22) Filed: Oct. 30, 2007

(30) Foreign Application Priority Data
Oct. 31, 2006 (KR) 10-2006-0106094

(51) Int. Cl. H02H 3/38

(52) U.S. Cl. 361/65

(57) ABSTRACT

A distribution automation system is disclosed. The system includes a switch for detecting a voltage/current status of electric power equipment to output the resulting detect signal, and supplying or cutting off power to the power equipment, and a control box including a control unit for converting the detect signal from the switch into a control signal, a distribution automation terminal unit for determining the presence or absence of a failure in the power equipment based on the control signal and controlling the switch according to a result of the determination, and a communication unit for transmitting the control signal to a central control station, wherein the control unit, the distribution automation terminal unit and the communication unit are formed on one board.

### BACKGROUND OF THE INVENTION

1. Field of the Invention

The present invention relates to a distribution automation system, and more particularly to a distribution automation system in which a control unit, a distribution automation terminal unit and a communication unit are integrated on one board, and a switch and a control box are formed integrally with each other.

2. Description of the Related Art

Most electric power facilities are installed outdoors, so that they are exposed to the risk of failures, such as a ground and short-circuit, caused by the natural environment including rain, wind, lightning and power surges, or birds or branches of trees.

On the other hand, as life environments are urbanized and become more sophisticated and intelligent, higher-quality power services are required, thereby making the scales of distribution systems larger and the configurations thereof complicated.

Therefore, in order to prevent social and economic damages resulting from unexpected power failure accidents, electric power companies introduce and run information communication technology-based distribution automation systems to monitor distribution systems at all times, minimize the damages and increase reliability of electric power supply.

FIG. 1 shows the configuration of such a conventional distribution automation system. As shown in this drawing, field equipment 100, installed on a pole to effect distribution automation, includes a switch 110 for detecting and handling a failure in a failure period of electric power equipment 200, and a control box 120. The control box 120 includes a control unit 121 for supplying electric power to the power equipment 200, converting the voltage/current status of the power equipment 200 into a control signal and transferring a drive signal to the switch 110, a distribution automation terminal unit 122, called a feeder remote terminal unit (FRTU), for determining the presence or absence of a failure in the power equipment 200 and performing a remote control based on a result of the determination, and a communication unit 123 connected to a communication network for transmitting the control signal to a central control station over the communication network.

Generally, the control box 120 is installed and run at the middle portion of the pole under the condition that it includes separate hardware units contained in separate housings, whereas the switch 110 is installed at the top portion of the pole because it must be present in the vicinity of a distribution line.

In this conventional system, modules having similar functions, such as power supply terminals, are duplicately used in the control box 120, because separate units are provided in the control box 120.

For this reason, each constituent element of the control box 120 is increased in size, adversely affecting the entire volume and weight of the control box 120. This becomes an issue in installing the control box 120 on the pole.

In the control box 120, power supply lines and data transmission lines for the respective units are connected in a complex manner, which leads to disadvantages in constructing, installing and operating the control box 120. Further, a cable connection interface portion for data transmission between the switch 110 and the control box 120 is exposed to external environments, resulting in degradation in reliability and stability of the system.

In addition, because a separate communication line is used for application of an information communication technique in the conventional distribution automation system, a lot of money must be paid for lease of the communication line.

### SUMMARY OF THE INVENTION

Therefore, the present invention has been made in view of the above problems, and it is an object of the present invention to provide a distribution automation system in which a control unit, a distribution automation terminal unit and a communication unit are integrated on one board.

It is another object of the present invention to provide a distribution automation system in which a switch and a control box are formed integrally with each other.

In accordance with the present invention, the above and other objects can be accomplished by the provision of a distribution automation system comprising: a switch for detecting a voltage/current status of electric power equipment to output the resulting detect signal, and supplying or cutting off power to the power equipment; and a control box including a control unit for converting the detect signal from the switch into a control signal, a distribution automation terminal unit for determining the presence or absence of a failure in the power equipment based on the control signal and controlling the switch according to a result of the determination, and a communication unit for transmitting the control signal to a central control station, wherein the control unit, the distribution automation terminal unit and the communication unit are formed on one board.

Preferably, the switch and the control box are installed within one housing.

More preferably, a partition wall is formed between the switch and the control box.

Preferably, the control unit comprises: an interface circuit for transferring the control signal to the distribution automation terminal unit; a driving circuit for applying a drive signal to the switch in response to a control command from the distribution automation terminal unit or a remote control command from the central control station; and a charging circuit.

Preferably, the communication unit comprises a power line communication modem which uses a power line as a communication line.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a conventional distribution automation system; and

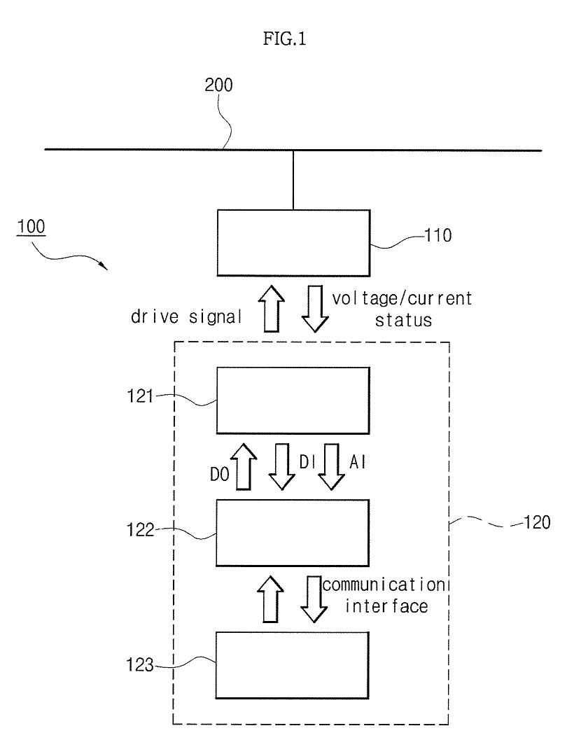

FIG. 2 is a block diagram showing the configuration of a distribution automation system according to the present invention.

### DETAILED DESCRIPTION OF THE PREFERRED EMBODIMENTS

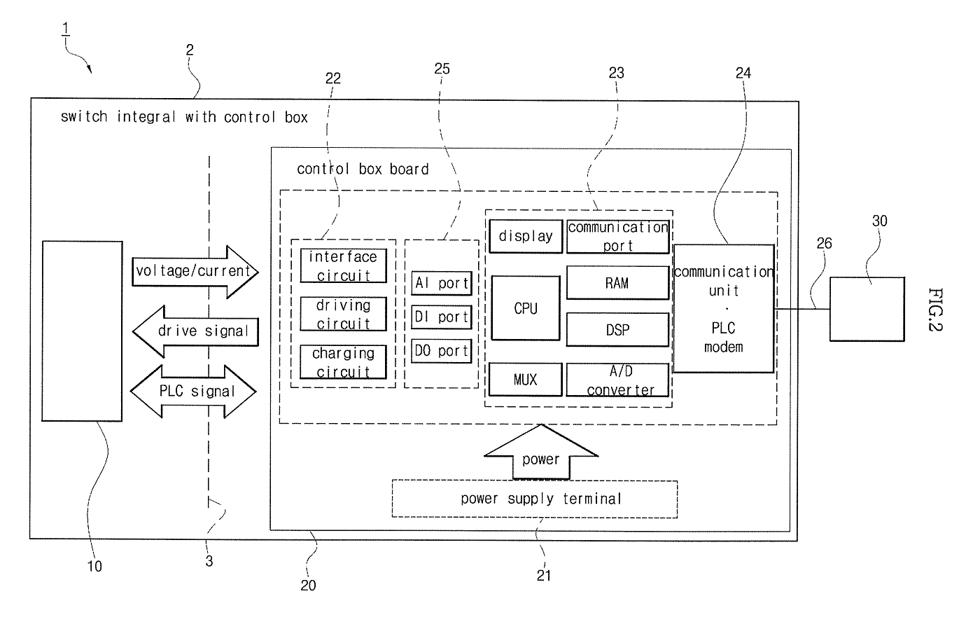

FIG. 2 shows the configuration of a distribution automation system according to the present invention. As shown in this drawing, the distribution automation system according to the present invention, denoted by reference numeral 1, includes a switch 10 for detecting the voltage/current status of electric power equipment, and a control box 20. The switch 10 and the control box 20 are installed within one housing 2 and separated from each other via a partition wall 3. The partition wall 3 is provided to enable a change or replacement in the control box 20 under the condition that a high voltage flows to the switch 10.

The control box 20 includes a control unit 22 including an interface circuit, driving circuit and charging circuit, a distribution automation terminal unit (feeder remote terminal unit (FRTU)) 23 including a central processing unit (CPU), digital signal processor (DSP) and analog/digital (A/D) converter, and a communication unit 24 equipped with a power line communication (PLC) modem. The control unit 22, the distribution automation terminal unit 23 and the communication unit 24 are formed on one board. Therefore, power supply terminals separately provided for the respective units 22, 23 and 24 are integrated into one power supply terminal 21 to supply power to the respective units 22, 23 and 24. Also, status information, control and drive signals are inputted and outputted through an analog input (AI) port, digital input (DI) port and digital output (DO) port of an input/output unit 25.

The interface circuit of the control unit 22 functions to transfer the voltage/current status of the power equipment detected by the switch 10 to the distribution automation terminal unit 23, and the driving circuit of the control unit 22 functions to apply a drive signal to the switch 10 in response to a control command from the distribution automation terminal unit 23 or a remote control command from a central control station 30. The charging circuit is preferably provided in the control unit 22 to cope with a power failure of the system.

In the present embodiment, the distribution automation terminal unit 23 further includes a display for displaying information regarding the current status of the system, a multiplexer (MUX) for multiplexing control and status information signals, and a random access memory (RAM) for storing data information. The DSP has excellent computation and program functions and cooperates with the CPU to compute/process an input signal.

The operation of the distribution automation system with the above-stated configuration according to the present invention will hereinafter be described.

If the switch 10 detects the voltage/current status of the electric power equipment, it transfers the resulting voltage/current status detect signal to the interface circuit of the control unit 22, which then transfers the voltage/current status detect signal as analog status information to the CPU of the distribution automation terminal unit 23 through the input/output unit 25.

The CPU receives the voltage/current status detect signal in the form of an analog or digital signal, computes it and controls the modules including the switch 10 in accordance with the computation result.

At this time, the computation result is also transferred to the power line communication modem of the communication unit 24 through a communication port of the distribution automation terminal unit 23 and then to the central control station 30 of the distribution automation system over a power line communication network 26.

On the other hand, although the distribution automation terminal unit 23 has been described to perform the central control operation, it may transmit a control signal based on the detect signal from the switch 10 to the central control station 30 and be subject to a remote control based on the control signal by the central control station 30.

In this case, a remote control command from the central control station 30 is transferred to the CPU via the power line communication modem and communication port. The CPU outputs a digital control signal for control of the switch 10 to the driving circuit in response to the remote control command from the central control station 30. Then, the driving circuit applies a drive signal to the switch 10 in response to the control signal from the CPU. As a result, the switch 10 supplies or cuts off power to the power equipment in response to the drive signal.

As apparent from the above description, according to the present invention, a control unit, a distribution automation terminal unit and a communication unit are integrated on one board, thereby making it possible to significantly reduce the size and weight of a control box.

Further, duplicate constituent elements having the same function, such as power supply modules, are integrated into one module, not separately provided in the respective units, thus curtailing a manufacturing cost.

Further, the control box is formed integrally with a switch for distribution automation. Therefore, it is possible to make the switch more intelligent and simplify the configuration of a distribution automation system installed on a pole.

In addition, the switch and the control box are separated from each other via a partition wall, thereby enabling a secure change or replacement in the control box under the condition that a high voltage flows to the switch.

Furthermore, a power line is used as a communication line. Therefore, it is possible to increase efficiency of infrastructure use of an electric power company and significantly reduce a communication line lease cost.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A distribution automation system comprising:
a switch for detecting a voltage/current status of electric power equipment to output the resulting detect signal, and supplying or cutting off power to the power equipment; and
a control box including a control unit for converting the detect signal from the switch into a control signal, a distribution automation terminal unit for determining the presence or absence of a failure in the power equipment based on the control signal and controlling the switch according to a result of the determination, and a communication unit for transmitting the control signal to a central control station,
wherein the control unit, the distribution automation terminal unit and the communication unit are formed on one board.

2. The distribution automation system according to claim 1, wherein the switch and the control box are installed within a housing, and a partition wall is formed between the switch and the control box.

3. The distribution automation system according to claim 1, wherein the control unit comprises:
an interface circuit for transferring the control signal to the distribution automation terminal unit; and
a driving circuit for applying a drive signal to the switch in response to a control command from the distribution automation terminal unit or a remote control command from the central control station.

4. The distribution automation system according to claim 1, wherein the communication unit comprises a power line communication modem which uses a power line as a communication line.
